(19) United States
(12) Patent Application Publication
(10) Pub. No.: US 2024/0373245 A1
(43) Pub. Date: Nov. 7, 2024

(54) SYSTEMS AND METHODS FOR SIDELINK TRANSMISSION OR RECEPTION

(71) Applicant: ZTE Corporation, Shenzhen, Guangdong (CN)

(72) Inventors: Yuzhou HU, Shenzhen (CN); Youxiong LU, Shenzhen (CN); Weimin XING, Shenzhen (CN); Haigang HE, Shenzhen (CN)

(73) Assignee: ZTE Corporation, Shenzhen, Guangdong (CN)

(21) Appl. No.: 18/778,618

(22) Filed: Jul. 19, 2024

Related U.S. Application Data
(63) Continuation of application No. PCT/CN2022/092773, filed on May 13, 2022.

(51) Int. Cl. H04W 16/14; H04B 7/06; H04L 1/1812; H04W 72/40; H04W 72/566; H04W 74/0816

(52) U.S. Cl. CPC H04W 16/14; H04B 7/0626; H04L 1/1812; H04W 72/40; H04W 72/566; H04W 74/0816

(57) ABSTRACT

Presented are systems and methods for sidelink transmission or reception. A wireless communication device (e.g., UE) may determine prioritization of communications at the wireless communication device. The communications may include at least one sidelink communication. At least one of the communications can be communicated over a shared spectrum.

### CROSS-REFERENCE TO RELATED APPLICATION

This application claims the benefit of priority under 35 U.S.C. § 120 as a continuation of PCT Patent Application No. PCT/CN2022/092773, filed on May 13, 2022, the disclosure of which is incorporated herein by reference in its entirety.

### TECHNICAL FIELD

The disclosure relates generally to wireless communications, including but not limited to systems and methods for sidelink transmission or reception.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., UE) may determine prioritization (e.g., an order of priority) of communications at the wireless communication device. The communications may include at least one sidelink communication. At least one of the communications can be communicated over a shared spectrum. The communications may include at least one uplink (UL) transmission. The at least one sidelink communication may comprise at least one physical sidelink feedback channel (PSFCH) transmission and at least one PSFCH reception. The at least one sidelink communication may comprise at least one new radio (NR) communication and at least one evolved universal mobile telecommunications system terrestrial radio access (E-UTRA) communication. The at least one sidelink communication may comprise at least one reference signal for various purposes (e.g. positioning reference signal for positioning purpose).

In some embodiments, the at least one sidelink communication may comprise at least one HARQ-ACK transmission communicated in a first physical uplink control channel (PUCCH). The communications may include at least one of: a HARQ-ACK transmission, a scheduling request (SR) transmission or a channel state information (CSI) transmission, communicated in a second PUCCH.

In some embodiments, the wireless communication device may determine the prioritization of the communications, prior to performing channel access for the at least one sidelink communication. The wireless communication device may perform the channel access for the at least one sidelink communication, after the determination of the prioritization of the communications. The wireless communication device may determine the prioritization of the communications, after performing the channel access for the at least one sidelink communication. The wireless communication device may perform the channel access for the at least one sidelink communication, prior to the determination of the prioritization of the communications. In certain embodiments, the channel access can be performed using listen before talk (LBT) of type 1, 2A, 2B, 2C or frame based equipment (FBE).

In some embodiments, the communications may include a first communication and a second communication. The first communication or the second communication can be communicated over a shared spectrum. The first communication can be a transmission and the second communication can be a reception, at the wireless communication device. The first communication can be on a first frequency, and the second communication can be on a second frequency. The first communication can be a prioritized transmission according to the prioritization of the communications, and the second communication can be a prioritized reception according to the prioritization of the communications. The first communication or the second communication can be a prioritized sidelink communication according to the prioritization of the communications. The first communication or the second communication can be a prioritized communication (e.g., determined or prioritized) according to the prioritization of the communication over the shared spectrum.

In some embodiments, the wireless communication device may determine the prioritization of the communications, prior to performing channel access for at least one of the communications. The wireless communication device may perform the channel access, after the determination of the prioritization of the communications. The wireless communication device may determine the prioritization of the communications, after performing the channel access. The wireless communication device may perform the channel access, prior to the determination of the prioritization of the communications.

In some embodiments, the wireless communication device may receive an indication of a priority threshold for the at least one sidelink communication via a higher layer signaling. The wireless communication device may determine/establish the prioritization of the communications according to a comparison of a priority level of the at least one sidelink communication, and the priority threshold.

In some embodiments, the wireless communication device may determine that the at least one sidelink communication may have a higher priority in the prioritization of the communications than another one of the communications, when the priority level is lower than the priority threshold. The wireless communication device may determine that the at least one sidelink communication may have a lower priority in the prioritization of the communications than the another one of the communications, when the priority level is higher than the priority threshold.

In some embodiments, the wireless communication device may receive an indication of a priority offset for the at least one sidelink communication via a higher layer signaling. The wireless communication device may determine the prioritization of communications according to a comparison of a priority level of the at least one sidelink communication adjusted by the priority offset, and a priority level of another one of the communications. In certain embodiments, the wireless communication device may determine that the at least one sidelink communication may have a higher priority in the prioritization of the communications than the another one of the communications, when the priority level adjusted by the priority offset is lower than the priority level of the another one. The wireless communication device may determine that the at least one sidelink communication may have a lower priority in the prioritization of the communications than the another one of the communications, when the priority level adjusted by the priority offset is higher than the priority level of the another one.

In some embodiments, the priority threshold or the priority offset can be configured or preconfigured according to a least one of: a success rate of listen before talk (LBT) operations; a failure rate of LBT operations; a channel busy ratio (CBR); or a channel occupancy ratio (CR). In some embodiments, the indication of the priority threshold or the priority offset may include at least one of: an indication of more than one priority threshold or priority offset corresponding to different success rates of listen before talk (LBT) operations; an indication of more than one priority threshold or priority offset corresponding to different failure rates of LBT operations; an indication of more than one priority threshold or priority offset corresponding to different channel busy ratios (CBRs); or an indication of more than one priority threshold or priority offset corresponding to different channel occupancy ratios (CRs).

In some embodiments, the wireless communication device may determine the prioritization of communications by: setting a higher priority to the at least one sidelink communication, in the prioritization of the communications relative to that of another one of the communications, when the at least one sidelink communication is communicated over the shared spectrum; or setting a lower priority to the at least one sidelink communication, in the prioritization of the communications relative to that of the another one of the communications, when the at least one sidelink communication is communicated over the shared spectrum.

In some embodiments, the wireless communication device may determine the prioritization of the communications by: setting a higher priority to the at least one sidelink communication, in the prioritization of the communications relative to that of another one of the communications, when a number of listen before talk (LBT) operations is larger than a defined threshold; or setting a lower priority to the at least one sidelink communication, in the prioritization of the communications relative to that of the another one of the communications, when the number of listen before talk (LBT) operations is larger than the defined threshold.

In some embodiments, the wireless communication device may perform a prioritized transmission over the shared spectrum according to the prioritization of the communications, by employing a defined type of channel access operation. The defined type may comprise at least one of: listen before talk (LBT) type 2A, 2B or 2C; an LBT type other than type 1 or frame based equipment (FBE); or a short control signaling transmission (SCSt) operation or no LBT operation.

In some embodiments, the wireless communication device may determine the prioritization of the communications prior to or after performing channel access for at least one of the communications, according to a configuration or pre-configuration.

In some embodiments, the wireless communication device may determine the prioritization of the communications according to at least one of: the communications whose listen before talk (LBT) operation provides an outcome that is successful, the communications over the shared spectrum or over one or more channels which are determined to be idle by channel access, or the communications over one or more spectrum other than the shared spectrum. The wireless communication device may perform a channel access operation over the shared spectrum.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a flow diagram of an example method for sidelink transmission or reception, in accordance with an embodiment of the present disclosure.

### DETAILED DESCRIPTION

### 1. Mobile Communication Technology and Environment

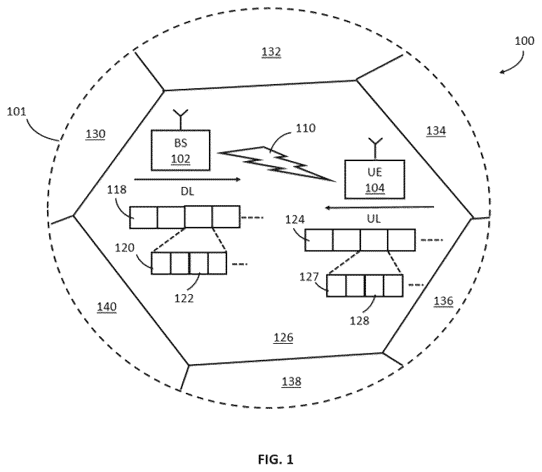

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes”, generally, which can practice the methods disclosed herein. Such communication nodes may be capable of wireless and/or wired communications, in accordance with various embodiments of the present solution.

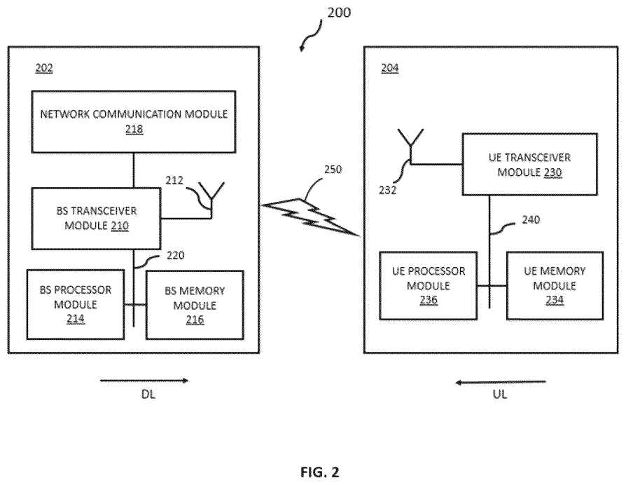

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (cNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for”, “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Sidelink Transmission or Reception

A user equipment (UE) may not be able to (e.g., may not have a capability to) receive and transmit signals simultaneously (e.g., at same time). If there are two signals needed/required to transmit, the UE may not be able to transmit the two signals at the same time (e.g., only one signal can be transmit first). One approach for deploying 5G new radio (NR) in unlicensed spectrum (NR-U) can be to signal/transmit/communicate in unlicensed 5 GHz and 6 GHz bands. An unlicensed/shared spectrum can be a designation of frequencies that may not have exclusive access. In a procedure of determining (prioritization of) the UE's transmission(s) and/or reception(s) in case of simultaneous transmission or reception of one or more of sidelink and/or uplink signals and/or channels, the introduction/use of listen before talk (LBT) operation for sidelink operation on an unlicensed/shared spectrum may incur/raise at least one of following issues. One of the issues may include a prioritization order between a LBT operation and a determination of (prioritization of) a UE's transmission(s) and/or reception(s) in the case/scenario of simultaneous transmission and/or reception (e.g., whether the LBT operation can be performed before or after the determination of the (prioritization of) the UE's transmission and/or reception in case of simultaneous transmission and/or reception). Another one of the issues may include a change to the LBT operation or the determination procedure depending on the prioritization order of the LBT operation and the determination of the UE's transmission and/or reception in case of simultaneous transmission and/or reception, to facilitate an efficient access and/or transmission. For example, a prioritization order may indicate that a NR signal has a higher priority. However, the LBT operation may sense/determine/indicate/show that the NR signal cannot be performed, which may result in delays associated to the NR signal.

The above issues can be resolved, and relevant solutions can be specified to ensure proper and consistent UE behavior, and to avoid conflicts. In this disclosure, a prioritization between sidelink communication/transmission/reception and channel access mechanism is discussed, which can provide an efficient/effective way for supporting sidelink transmission and/or reception.

LBT type 1, 2A, 2B, 2C, or frame based equipment (FBE) may be used for performing a sidelink channel access mechanism as a LBT operation for a transmission for sidelink signals/channels. LBT can be a transmission sensing mechanism, by which each device may locate/determine transmission opportunities based on self-detection of channel availability. Sensing/operation time of LBT type 2A, 2B, or 2C may be shorter than sensing/operation time of LBT type 1 or FBE. FBE can be another channel access mechanism based on LBT, in which unlicensed devices may contend for a channel beginning at synchronized frame boundaries.

In some embodiments, prioritization of transmissions/receptions may be performed/determined between a NR signal and a LTE signal by a UE. In some embodiments, prioritization of transmissions/receptions may be determined/performed among NR sidelinks by a UE. In some embodiments, prioritization of transmissions/receptions may be determined/performed between a NR sidelink and an uplink transmission (e.g., a radio interface between universal terrestrial radio access network and a UE) by a UE. By way of illustration, the following examples include features that can be individually applied or combined in any order or manner (e.g., across one or more examples).

### Solution Example 0

A UE may determine prioritization of communications at the UE. The communications may include at least one sidelink communication (e.g., sidelink transmission or sidelink reception). In some embodiments, the communications may include at least one uplink (UL) transmission. In some embodiments, the communications (e.g., sidelink communications) may comprise at least one physical sidelink feedback channel (PSFCH) transmission, at least one PSFCH reception, and/or at least one transmission or reception of reference signal for various purposes (e.g. sidelink positioning reference signal for positioning purpose). In some embodiments, the communications (e.g., sidelink communications) may comprise at least one new radio (NR) communication and/or at least one evolved universal mobile telecommunications system terrestrial radio access (E-UTRA) communication. In certain embodiments, the communications (e.g., sidelink communications) may include at least one of: a HARQ-ACK transmission, a scheduling request (SR) transmission and/or a channel state information (CSI) transmission, communicated in a physical uplink control channel (PUCCH).

At least one of the communications can be communicated over a shared/unlicensed spectrum. For a sidelink operation over shared spectrum channel access (e.g., at least one sidelink communication can be in unlicensed spectrum), a UE may determine to perform prioritization between sidelink (SL) transmissions/receptions and UL transmissions. For example, the UE may determine/perform prioritization between a sidelink transmission and an uplink transmission at the UE. The UE may determine/establish a prioritization sequence/order for the communications according to the prioritization. A communication with higher priority in the prioritization sequence may be transmitted/received earlier (or communicated preferentially over another communication) at the UE. In certain embodiments, the UE may determine prioritization/priority among a sidelink reception, a sidelink transmission, and an uplink transmission at the UE.

### Solution Example 1

A UE may determine prioritization of communications at the UE. The communications may include at least one sidelink communication (e.g., sidelink transmission or sidelink reception). In some embodiments, the communications may include at least one uplink (UL) transmission. The at least one of the communications can be communicated over a shared/unlicensed spectrum. In some embodiments, a UE may determine an order/sequence of performing prioritization of the communications and performing channel access mechanism (e.g., LBT operation) for the communications at the UE. The channel access mechanism may include LBT operation type 1, 2A, 2B, 2C, or FBE.

For an operation (e.g., a sidelink transmission/reception) over shared/unlicensed spectrum channel access for instance, a UE may perform/determine prioritization between sidelink transmissions/receptions and UL transmissions, before performing/initiating a channel access mechanism for sidelink transmissions/receptions. For example, the UE may determine/perform prioritization between a sidelink transmission and an uplink transmission at the UE. The UE may establish a prioritization sequence (or an order of priority) for the communications. A communication with higher priority (e.g., smaller priority value) in the prioritization sequence may proceed if a LBT operation successfully determines a transmission opportunity. If the LBT operation is successful (e.g., a transmission opportunity is available, and/or the shared spectrum/channels where the communications take place are sensed to be idle by channel access such as LBT operation), the communication with higher priority can be transmitted by the UE.

In some embodiments, for an operation (e.g., a sidelink transmission/reception) over shared/unlicensed spectrum channel access, a UE may perform channel access for sidelink transmissions/receptions, after performing prioritization between sidelink transmissions/receptions and UL transmissions.

In some embodiments, for an operation (e.g., a sidelink transmission/reception) over shared/unlicensed spectrum channel access for instance, a UE may perform/determine prioritization between sidelink transmissions/receptions and UL transmissions, after performing channel access for sidelink transmissions/receptions.

In some embodiments, for an operation (e.g., a sidelink transmission/reception) over shared/unlicensed spectrum channel access, a UE may perform channel access for sidelink transmissions/receptions, before performing prioritization between sidelink transmissions/receptions and UL transmissions.

### Solution Example 2

A UE may determine prioritization of communications at the UE. The communications may include at least one sidelink communication (e.g., sidelink transmission and/or sidelink reception). In some embodiments, the at least one sidelink communication may comprise at least one physical sidelink feedback channel (PSFCH) transmission and at least one PSFCH reception. The at least one sidelink communication can be a new radio (NR) communication or an evolved universal mobile telecommunications system terrestrial radio access (E-UTRA) (e.g., long term evolution (LTE)) communication. The at least one of the communications can be communicated over a shared/unlicensed spectrum. In some embodiments, a UE may determine an order of performing prioritization of the communications and performing a channel access mechanism (e.g., LBT operation) for the communications at the UE. The channel access mechanism may include LBT operation type 1, 2A, 2B, 2C, or FBE.

For an operation (e.g., a sidelink transmission/reception) over shared/unlicensed spectrum channel access, a UE may perform/determine prioritization between PSFCH transmissions and PSFCH receptions, before performing channel access (e.g., activate a channel access mechanism) for the PSFCH transmissions and/or the PSFCH receptions. For example, the UE may determine/perform prioritization between PSFCH transmissions and PSFCH receptions at the UE. The UE may establish a prioritization sequence for the communications according to prioritization determination/operation. A communication with higher priority (e.g., PSHCH transmission) in the prioritization sequence may proceed if a LBT operation has already completed successfully or can complete successfully. If an outcome of the LBT operation is successful, the communication (e.g., PSFCH transmission) with higher priority can be transmitted by the UE.

In some embodiments, for an operation (e.g., a sidelink transmission/reception) over shared/unlicensed spectrum channel access, a UE may perform/determine prioritization between PSFCH transmissions and PSFCH receptions, after performing/completing channel access for the PSFCH transmissions and/or the PSFCH receptions.

In some embodiments, for an operation (e.g., a sidelink transmission/reception) over shared/unlicensed spectrum channel access for instance, a UE may perform/determine channel access for the PSFCH transmissions and/or the PSFCH receptions, before performing prioritization between the PSFCH transmissions and the PSFCH receptions.

In some embodiments, for an operation (e.g., a sidelink transmission/reception) over shared/unlicensed spectrum channel access, a UE may perform/activate a channel access mechanism for the PSFCH transmissions and/or the PSFCH receptions, after performing prioritization between the PSFCH transmissions and the PSFCH receptions.

### Solution Example 3

A UE may determine prioritization of communications at the UE. The communications may include at least one sidelink communication (e.g., sidelink transmission and/or sidelink reception). In some embodiments, the at least one sidelink communication may comprise at least one new radio (NR) communication and/or at least one evolved universal mobile telecommunications system terrestrial radio access (E-UTRA) communication. The at least one of the communications (e.g., NR sidelink communication) can be communicated over a shared/unlicensed spectrum. In some embodiments, a UE may determine an order of performing prioritization of the communications and performing channel access mechanism (e.g., LBT operation) for the communications at the UE. The channel access mechanism may include LBT operation type 1, 2A, 2B, 2C, or FBE.

For an operation (e.g., a NR sidelink transmission/reception) over shared/unlicensed spectrum channel access for example, a UE may perform/determine prioritization between NR sidelink transmissions/receptions (e.g., NR transmission in a sidelink channel) and E-UTRA sidelink transmissions/receptions (e.g., E-UTRA transmission in a sidelink channel), before performing/activating/triggering a channel access mechanism for the NR sidelink and/or E-UTRA transmissions and/or receptions. For example, the UE may determine/perform prioritization between a NR transmission and an E-UTRA transmission in a sidelink channel at the UE. The UE may establish/determine a prioritization sequence for the communications according to a prioritization process/determination. A communication with higher priority (e.g., NR transmission in the sidelink channel) in the prioritization sequence may proceed or be blocked, according to a result/outcome of a LBT operation. If an outcome/evaluation/assessment of the LBT operation is successful/positive, the communication (e.g., NR transmission in the sidelink channel) with higher priority can be transmitted/received by the UE.

In some embodiments, for an operation (e.g., a NR sidelink transmission/reception) over shared/unlicensed spectrum channel access, a UE may perform/determine prioritization between NR sidelink transmissions/receptions and/or E-UTRA sidelink transmissions/receptions, after performing/triggering a channel access mechanism for the NR sidelink and/or E-UTRA transmissions and/or receptions.

In some embodiments, for an operation (e.g., a NR sidelink transmission/reception) over shared/unlicensed spectrum channel access, a UE may perform/trigger channel access for the NR sidelink and/or E-UTRA transmissions and/or receptions, before performing prioritization between NR sidelink transmissions/receptions and/or E-UTRA sidelink transmissions/receptions

In some embodiments, for an operation (e.g., a NR sidelink transmission/reception) over shared/unlicensed spectrum channel access, a UE may perform/trigger a channel access mechanism for the NR sidelink and/or E-UTRA transmissions and/or receptions, after performing prioritization between NR sidelink transmissions/receptions and/or E-UTRA sidelink transmissions/receptions

### Solution Example 4

A UE may determine prioritization of communications at the UE. The communications may include at least one sidelink communication (e.g., sidelink transmission and/or sidelink reception). In some embodiments, the communications may include at least one uplink (UL) transmission. The at least one of the communications can be communicated over a shared/unlicensed spectrum. In certain embodiments, the at least one of the communications may not be communicated over a shared/unlicensed spectrum. For example, the at least one communications can be one sidelink transmission and one sidelink reception. In some embodiments, the sidelink transmission can be communicated over a shared/unlicensed spectrum. The sidelink reception may not be communicated over a shared/unlicensed spectrum. In certain embodiments, both of the sidelink transmission and the sidelink reception can be communicated over a shared/unlicensed spectrum. In some embodiments, a UE may determine an order/sequence of performing prioritization of the communications and performing channel access (e.g., LBT operation) for the communications at the UE. The channel access mechanism may include LBT operation type 1, 2A, 2B, 2C, or FBE.

For an operation (e.g., a sidelink transmission/reception) over shared/unlicensed spectrum channel access for instance, a UE may perform/determine prioritization between sidelink transmissions/receptions and UL transmissions, before performing channel access mechanism for sidelink transmissions/receptions. For example, the UE may determine/perform prioritization between a sidelink transmission and a sidelink reception at the UE. The UE may determine/arrange/organize a prioritization sequence for the communications according to a determination of prioritization/priority. A communication with higher priority (e.g., sidelink transmission) in the prioritization sequence may be evaluated/assessed by a LBT operation. If an outcome/evaluation/assessment of the LBT operation is successful, the communication with higher priority (e.g., sidelink transmission) can be transmitted by the UE.

In some embodiments, for an operation (e.g., a sidelink transmission/reception) over shared/unlicensed spectrum channel access, a UE may perform channel access for sidelink transmissions/receptions, after performing prioritization between sidelink transmissions/receptions and UL transmissions.

In some embodiments, for an operation (e.g., a sidelink transmission/reception) over shared/unlicensed spectrum channel access, a UE may perform/determine prioritization between sidelink transmissions/receptions and UL transmissions, after performing/triggering/executing a channel access mechanism for sidelink transmissions/receptions.

In some embodiments, for an operation (e.g., a sidelink transmission/reception) over shared/unlicensed spectrum channel access, a UE may perform/channel access for sidelink transmissions/receptions, before performing prioritization between sidelink transmissions/receptions and UL transmissions.

### Solution Example 5

A base station (BS) may trigger a sidelink transmission/reception between a first UE and a second UE. The first UE (e.g., responsive to receiving the sidelink communication) can respond with a sidelink hybrid automatic repeat request acknowledgement (HARQ-ACK) information in a physical uplink control channel (PUCCH) to the BS. In some embodiments, one of the UEs may perform prioritization of communications. The communications may include at least one sidelink communication. The at least one sidelink communication may comprise at least one sidelink HARQ-ACK transmission communicated in a first PUCCH. In some embodiments, the communications may include at least one of: a HARQ-ACK transmission, a scheduling request (SR) transmission and/or a channel state information (CSI) transmission, communicated in a second PUCCH (e.g., different from the first PUCCH). The at least one of the communications can be communicated over a shared/unlicensed spectrum. In certain embodiments, the at least one of the communications may not be communicated over a shared/unlicensed spectrum. In some embodiments, one of the UEs may determine order of performing prioritization of the communications and performing/triggering a channel access mechanism (e.g., LBT operation) for the communications at one of the UEs. The channel access mechanism may include LBT operation type 1, 2A, 2B, 2C, or FBE.

For an operation (e.g., a HARQ-ACK transmission communicated in a PUCCH) over shared/unlicensed spectrum channel access, a UE may perform/determine prioritization between a sidelink HARQ-ACK transmission communicated in the first PUCCH and another communication (e.g., a DL/UL HARQ-ACK, a UL scheduling request (SR), or a UL channel state information (CSI)) in a second PUCCH, before performing channel access mechanism for the communications. For example, the UE may determine/perform prioritization between a sidelink HARQ-ACK transmission communicated in the first PUCCH and a UL scheduling request in the second PUCCH at the UE. The UE may establish a prioritization sequence for the communications according to a determination of prioritization/priority for the communications. A communication with a higher priority (e.g., a sidelink HARQ-ACK transmission communicated in the first PUCCH) in the prioritization sequence may be evaluated/assessed by a LBT operation. If an outcome/evaluation/assessment of the LBT operation is successful (e.g. the shared spectrum/channels where the communications take place are sensed to be idle by channel access such as LBT operation), the communication with higher priority (e.g., sidelink HARQ-ACK transmission communicated in the first PUCCH) can be transmitted by the UE.

In some embodiments, for an operation (e.g., a HARQ-ACK transmission communicated in a PUCCH) over shared/unlicensed spectrum channel access, a UE may perform/determine prioritization between a sidelink HARQ-ACK transmission communicated in the first PUCCH and another communication (e.g., a DL/UL HARQ-ACK, a UL scheduling request (SR), or a UL channel state information (CSI)) in a second PUCCH, after performing channel access mechanism for the communications.

In some embodiments, for an operation (e.g., a HARQ-ACK transmission communicated in a PUCCH) over shared/unlicensed spectrum channel access, a UE may perform channel access for the communications, before performing prioritization between a sidelink HARQ-ACK transmission communicated in the first PUCCH and another communication (e.g., a DL/UL HARQ-ACK, a UL scheduling request (SR), or a UL channel state information (CSI)) in a second PUCCH.

In some embodiments, for an operation (e.g., a HARQ-ACK transmission communicated in a PUCCH) over shared/unlicensed spectrum channel access, a UE may perform/trigger channel access for (e.g., at least one of) the communications, after performing prioritization between a sidelink HARQ-ACK transmission communicated in the first PUCCH and another communication (e.g., a DL/UL HARQ-ACK, a UL scheduling request (SR), or a UL channel state information (CSI)) in a second PUCCH.

### Solution Example 6

A UE may determine prioritization of communications at the UE. The communications may include a first communication and a second communication. In some embodiments, there can be a third communication, a fourth communication, etc. The first communication or the second communication can be communicated over a shared/unlicensed spectrum. In some embodiments, the first communication or the second communication can be communicated over a licensed spectrum. In some embodiments, the first communication can be a transmission and the second communication can be a reception, at the UE. In some embodiments, the first communication can be on a first frequency, and the second communication can be on a second frequency. In some embodiments, the first communication can be a prioritized transmission (e.g. the transmission with the highest priority) according to the prioritization of the communications, and the second communication can be a prioritized reception according to the prioritization of the communications. In some embodiments, the first communication can be a transmission that can be prioritized according to the prioritization of the communications, and the second communication can be a transmission that can be prioritized according to the prioritization of the communications. In some embodiments, the first communication or the second communication can be a prioritized sidelink communication (e.g. the sidelink communication with the highest priority) according to the prioritization of the communications. The first communication or the second communication can be a prioritized communication (e.g. the communication with the highest priority) according to the prioritization of the communication over the shared spectrum. In some embodiments, a UE may determine an order of performing prioritization of the communications and performing channel access mechanism (e.g., LBT operation) for the communications at the UE. The channel access mechanism may include LBT operation type 1, 2A, 2B, 2C, or FBE.

For an operation (e.g., one of the communications) over shared/unlicensed spectrum channel access for example, a UE may perform/determine prioritization between the first communication transmissions/receptions and the second communication transmissions/receptions, before performing channel access mechanism for the communications. For example, the UE may determine/perform prioritization between a first communication transmission and a second communication transmission at the UE. The UE may establish/determine/form a prioritization sequence/order for the communications according to a prioritization determination process. A communication with higher priority (e.g., second communication transmission) in the prioritization sequence may proceed or be blocked based on a LBT operation. If an outcome/result of the LBT operation is successful (e.g., a transmission opportunity for the communication is identified/established, and/or the communications over shared spectrum or channels where the communications take place are sensed to be idle by channel access), the communication with higher priority (e.g., second communication transmission) can be transmitted by the UE.

For an operation (e.g., one of the communications) over shared/unlicensed spectrum channel access, a UE may perform/determine prioritization between the first communication (e.g., transmissions/receptions) and the second communication (e.g., transmissions/receptions), after performing channel access mechanism for the communications.

In some embodiments, for an operation (e.g., one of the communications) over shared/unlicensed spectrum channel access, a UE may perform/trigger channel access for (at least one of) the communications, after performing prioritization between the first communication transmissions/receptions and the second communication transmissions/receptions.

In some embodiments, for an operation (e.g., one of the communications) over shared/unlicensed spectrum channel access, a UE may perform channel access for the communications, before performing prioritization between the first communication transmissions/receptions and the second communication transmissions/receptions.

### Solution Example 7

A UE may determine prioritization of communications at the UE. The communications may include at least one sidelink communication (e.g., sidelink transmission and/or sidelink reception). The at least one of the communications can be communicated over a shared/unlicensed spectrum. The UE may receive an indication of a priority threshold for the at least one sidelink communication via a higher layer signaling (e.g., a radio resource control (RRC) signaling or a MAC control element (CE) signaling). The UE may determine prioritization of the communications according to a comparison of a priority level of the at least one sidelink communication, and the priority threshold.

For an operation (e.g., sidelink transmission/receptions) over shared/unlicensed spectrum channel access, a radio resource control (RRC) parameter providing a priority threshold can be configured for sidelink transmissions/receptions to determine prioritization between simultaneous sidelink transmissions/receptions (e.g., same time sidelink transmissions/receptions). When a priority level/value of a sidelink transmission is smaller than the priority threshold, the sidelink transmission may have a higher priority than a simultaneous (e.g., concurrently scheduled, or at least partially overlapping) transmission or reception. Lower priority level/value may indicate higher priority over other simultaneous transmission or reception. When the priority level/value of a sidelink transmission is larger than the priority threshold, the other (e.g., non-sidelink) simultaneous transmission or reception may have a higher priority than the sidelink transmission.

In some embodiments, the UE may determine an order of performing prioritization of the communications and performing channel access mechanism (e.g., LBT operation) for the communications at the UE as per solution examples 1-6.

In some embodiments, the priority threshold can be the only indication for the communications. If a priority level/value of a sidelink transmission is smaller than the priority threshold, the sidelink transmission may be transmitted by the UE regardless of the outcome of the LBT operation. In certain embodiments, the sidelink transmission may be transmitted by the UE without performing any LBT operation and/or using a short control signaling transmission.

In some embodiments, if the priority threshold is not configured, preconfigured, or fitting (e.g., is inconsistent with or conflicts with) the behaviour of the UE, the previous prioritization rule/standard (e.g., any solution from examples 1-6) may be applied.

### Solution Example 8

A UE may determine prioritization of communications at the UE. The communications may include at least one sidelink communication (e.g., sidelink transmission and/or sidelink reception). The at least one of the communications can be communicated over a shared/unlicensed spectrum. The UE may receive an indication of a priority offset for the at least one sidelink communication via a higher layer signaling (e.g., a radio resource control (RRC) or a MAC control element (CE)). The UE may determine prioritization of the communications according to a comparison of a priority level of the at least one sidelink communication adjusted/modified (e.g., can be increased or subtracted) by the priority offset, and a priority level of another one of the communications. For example, a priority level/value of a first sidelink communication can be 3, and a priority level/value of a second sidelink communication can be 4. A priority offset for the at least one sidelink communication can be 2. The UE may adjust the priority level/value of the first sidelink communication (e.g., 3) by adding the priority offset (e.g., 2), and may obtain an adjusted priority level/value (e.g., 5). The UE may determine prioritization of the communications according to a comparison of the adjusted priority level/value (e.g., 5) of the first sidelink communication, and the priority level/value (e.g., 4) of the second sidelink communications.

For an operation (e.g., sidelink transmission and/or sidelink reception) over shared/unlicensed spectrum channel access, a radio resource control (RRC) parameter providing a priority offset (e.g., can be added to or subtracted from a priority level/value of a sidelink transmission) can be configured for sidelink transmissions/receptions to determine a prioritization between simultaneous sidelink transmissions/receptions (e.g., same time sidelink transmissions/receptions).

When a priority level/value of a sidelink transmission adjusted by the priority offset is smaller than the priority of another transmission/reception, the sidelink transmission may have a higher priority than a simultaneous transmission or reception. A lower priority level/value may indicate a higher priority over other simultaneous transmission(s) and/or reception(s). When the priority level/value of a sidelink transmission modified by the priority offset is larger than the priority of the transmission, the other (e.g., non-sidelink) simultaneous transmission or reception may have a higher priority than the sidelink transmission.

In some embodiments, the UE may determine an order of performing prioritization of the communications and performing channel access mechanism (e.g., LBT operation) for the communications at the UE as per solution examples 1-6.

### Solution Example 9

In some embodiments, the priority threshold (in solution example 7) or the priority offset (in solution example 8) can be configured or preconfigured according to a least one of: a success rate of listen before talk (LBT) operations; a failure rate of LBT operations; a channel busy ratio (CBR) (e.g., considering WiFi existence); or a channel occupancy ratio (CR) (e.g., considering WiFi existence).

The success rate of LBT operations can be defined as a number of successful outcomes in a certain/total number of LBT sensing/testing/checking operations. For example, if the number of LBT sensing operations is 5 and the number of successful outcomes is 1, the success rate of LBT operations can be ⅕ (20%).

The failure rate of LBT operations can be defined as a number of failure outcomes in a certain/total number of LBT sensing operations. For example, if the number of LBT sensing operation is 5 and the number of failure outcomes is 3, the failure rate of LBT operations can be ⅗ (60%).

The channel busy ratio (CBR) can be defined as a portion of subchannels in a resource pool whose received signal strength indicator (RSSI) measured may exceed a pre-configured threshold. Such a metric can be determined/calculated/sensed over the last 100 (or other number of) subframes for instance. The CBR may provide an estimate on the overall/specific state of the channel.

The channel occupancy ratio (CR) can be calculated at subframe n. The CR can be defined as a total number of subchannels used for transmissions in subframes [n−a, n−1] and granted in subframes [n, n+b] divided by the total number of subchannels within [n−a, n+b], wherein a and b can be determined by a BS with limitation of a+b+1=1000 and a≥500. The CR may provide an indication of (the amount of) channel utilization by a transmitter itself.

### Solution Example 10

A UE may determine prioritization of communications by setting a higher priority to a first communication (e.g., the at least one sidelink communication), in the prioritization of the communications relative to that of another one of the communications, when the at least one sidelink communication is communicated over the shared spectrum. In some embodiments, the UE may determine prioritization of communications by setting a lower priority to the at least one sidelink communication, in the prioritization of the communications relative to that of the another one or more of the communications, when the at least one sidelink communication is communicated over the shared spectrum. For an operation (e.g., a sidelink transmission/reception) over shared spectrum channel access, a sidelink transmission over shared spectrum can always be prioritized (e.g., having lower priority level/value) over other simultaneous receptions/transmissions. For example, the UE may determine a prioritization of sidelink transmission A, sidelink transmission B, and sidelink transmission C in an unlicensed/shared spectrum. The order of prioritization can be sidelink transmission C (having higher priority)>sidelink transmission B>sidelink transmission A (having lower priority). The sidelink transmission A may always be prioritized (even though the sidelink transmission A has a lower priority in the order of prioritization) over an uplink transmission in licensed spectrum.

In certain embodiments, for an operation (e.g., a sidelink transmission/reception) over shared spectrum channel access, a sidelink transmission over shared spectrum may always be (e.g., having higher priority level/value) deprioritized over other simultaneous receptions/transmissions.

### Solution Example 11

For an operation (e.g., a sidelink transmission/reception) over shared spectrum channel access, a sidelink transmission over shared spectrum can be prioritized/deprioritized over simultaneous receptions/transmissions conditioned on (or according to) the number of LBT operations performed (e.g., for sidelink transmission/reception or for simultaneous transmission/reception) that is larger than a pre-configured or configured threshold. The pre-configured or configured threshold can be predefined (e.g., a predefined threshold) or configured (e.g., determined, calculated, computed, signaled/indicated) by a BS (e.g., the UE receiving a threshold from the BS) before the operation.

In some embodiments, the UE may determine the prioritization of the communications by: setting a higher priority to the at least one sidelink communication, in the prioritization of the communications relative to that of another one of the communications, when a number of listen before talk (LBT) operations is larger than a defined threshold; or setting a lower priority to the at least one sidelink communication, in the prioritization of the communications relative to that of the another one of the communications, when the number of listen before talk (LBT) operations is larger than the defined threshold. For example, if a sidelink transmission has failed 5 times during LBT operations, the sidelink transmission can be prioritized to be transmitted (e.g., to ensure that it gets transmitted) or deprioritized for transmission (e.g., since the side link transmission is likely to be unsuccessful). In the former case, the sidelink transmission may be configured to have higher priority. The setting for a higher priority to the sidelink transmission after the number of LBT operations (e.g., 5 times) can improve sidelink transmission efficiency and performance. For another example, if a sidelink transmission has failed 6 times during LBT operations, the sidelink transmission can be deprioritized to be transmitted. In such case, the sidelink transmission may include lower priority information. By dropping the sidelink transmission, transmission efficiency may be improved.

### Solution Example 12

In some embodiments, the wireless communication device may perform a prioritized transmission over the shared spectrum according to the prioritization of the communications, by employing a defined type of channel access operation. The defined type may comprise at least one of: listen before talk (LBT) type 2A, 2B or 2C; an LBT type other than type 1 or frame based equipment (FBE); or a short control signaling transmission (SCSt) operation or no LBT operation. LBT type 2A, 2B or 2C may have a shorter sensing time than LBT type 1 or FBE.

### Solution Example 13

In some embodiments, the UE may determine the prioritization of the communications prior to or after performing channel access for at least one of the communications, according to a configuration or pre-configuration. The configuration can be configured (e.g., determined, calculated, computed) by a BS/UE during an operational/communication sessions for instance. The pre-configuration can be predefined (e.g., a predefined configuration) or configured (e.g., determined, calculated, computed) by a BS (e.g., the UE receiving a configuration from the BS) before the operational session.

For an operation (e.g., a sidelink transmission/reception) over shared/unlicensed spectrum channel access, a UE may perform/determine prioritization between sidelink communication and non-sidelink communication, before performing channel access mechanism for the sidelink communication.

### Solution Example 14

In some embodiments, for an operation (e.g., communications) over shared/unlicensed spectrum channel access for instance, a UE may perform/determine channel access (e.g., LBT operation) for the communications. The UE may determine the prioritization of the communications for the communications whose LBT operations are successful (e.g., a transmission opportunity is available, and/or the shared spectrum/channels where the communications take place are sensed to be idle by channel access such as LBT operation).

For example, the prioritization determination/operation may take place between a communication over unlicensed/shared spectrum whose LBT operation is successful and the communications over one or more spectrum other than the unlicensed (shared) spectrum.

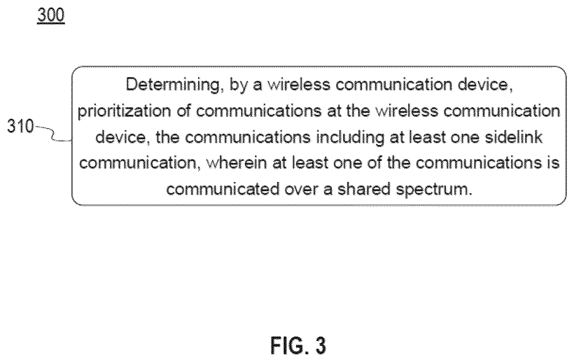

FIG. 3 illustrates a flow diagram of a method 300 for sidelink transmission or reception. The method 300 may be implemented using any one or more of the components and devices detailed herein in conjunction with FIGS. 1-2. In overview, the method 300 may be performed by a wireless communication device (e.g., a UE), in some embodiments. Additional, fewer, or different operations may be performed in the method 300 depending on the embodiment. At least one aspect of the operations is directed to a system, method, apparatus, or a computer-readable medium.

A wireless communication device (e.g., UE) may determine prioritization of communications at the wireless communication device (operation 310). The communications may include at least one sidelink communication. At least one of the communications can be communicated over a shared spectrum. At least another one of the communications can be communicated over a spectrum/band that is other than a shared spectrum. The communications may include at least one uplink (UL) transmission. The at least one sidelink communication may comprise at least one physical sidelink feedback channel (PSFCH) transmission (e.g., a communication via a PSFCH) and at least one PSFCH reception (e.g., a communication via the same or another PSFCH). The at least one sidelink communication may comprise at least one new radio (NR) communication and/or at least one evolved universal mobile telecommunications system terrestrial radio access (E-UTRA) communication.

In some embodiments, the at least one sidelink communication may comprise at least one HARQ-ACK transmission communicated in a first physical uplink control channel (PUCCH). The communications may include at least one of: a HARQ-ACK transmission, a scheduling request (SR) transmission or a channel state information (CSI) transmission, communicated in a second PUCCH.

In some embodiments, the wireless communication device may determine the prioritization of the communications, prior to performing channel access for the at least one sidelink communication. The wireless communication device may perform the channel access for the at least one sidelink communication, after the determination of the prioritization of the communications. The wireless communication device may determine the prioritization of the communications, after performing the channel access for the at least one sidelink communication. The wireless communication device may perform the channel access for the at least one sidelink communication, prior to the determination of the prioritization of the communications. In certain embodiments, the channel access can be performed using listen before talk (LBT) of type 1, 2A, 2B, 2C or frame based equipment (FBE).

In some embodiments, the communications may include a first communication and a second communication. The first communication or the second communication can be communicated over a shared spectrum. The first communication can be a transmission and the second communication can be a reception, at the wireless communication device. The first communication can be on a first frequency, and the second communication can be on a second frequency. The first communication can be a prioritized transmission according to the prioritization of the communications, and the second communication can be a prioritized reception according to the prioritization of the communications. The first communication or the second communication can be a prioritized sidelink communication according to the prioritization of the communications. The first communication or the second communication can be a prioritized communication according to the prioritization of the communication over the shared spectrum.

In some embodiments, the wireless communication device may determine the prioritization of the communications, prior to performing channel access for at least one of the communications. The wireless communication device may perform the channel access, after the determination of the prioritization of the communications. The wireless communication device may determine the prioritization of the communications, after performing the channel access. The wireless communication device may perform the channel access, prior to the determination of the prioritization of the communications.

In some embodiments, the wireless communication device may receive an indication of a priority threshold for the at least one sidelink communication via a higher layer signaling. The wireless communication device may determine the prioritization of the communications according to a comparison of a priority level of the at least one sidelink communication, and the priority threshold.

In some embodiments, the wireless communication device may determine that the at least one sidelink communication may have a higher priority in the prioritization of the communications than another one of the communications, when the priority level is lower than the priority threshold. The wireless communication device may determine that the at least one sidelink communication may have a lower priority in the prioritization of the communications than the another one of the communications, when the priority level is higher than the priority threshold.

In some embodiments, the wireless communication device may receive an indication of a priority offset for the at least one sidelink communication via a higher layer signaling. The wireless communication device may determine the prioritization of communications according to a comparison of a priority level of the at least one sidelink communication adjusted by the priority offset, and a priority level of another one of the communications. In certain embodiments, the wireless communication device may determine that the at least one sidelink communication may have a higher priority in the prioritization of the communications than the another one of the communications, when the priority level adjusted by the priority offset is lower than the priority level of the another one. The wireless communication device may determine that the at least one sidelink communication may have a lower priority in the prioritization of the communications than the another one of the communications, when the priority level adjusted by the priority offset is higher than the priority level of the another one.

In some embodiments, the priority threshold or the priority offset can be configured or preconfigured according to a least one of: a success rate of listen before talk (LBT) operations; a failure rate of LBT operations; a channel busy ratio (CBR); or a channel occupancy ratio (CR). In some embodiments, the indication of the priority threshold or the priority offset may include at least one of: an indication of more than one priority threshold or priority offset corresponding to different success rates of listen before talk (LBT) operations; an indication of more than one priority threshold or priority offset corresponding to different failure rates of LBT operations; an indication of more than one priority threshold or priority offset corresponding to different channel busy ratios (CBRs); or an indication of more than one priority threshold or priority offset corresponding to different channel occupancy ratios (CRs).

In some embodiments, the wireless communication device may determine the prioritization of communications by: setting a higher priority to the at least one sidelink communication, in the prioritization of the communications relative to that of another one of the communications, when the at least one sidelink communication is communicated over the shared spectrum; or setting a lower priority to the at least one sidelink communication, in the prioritization of the communications relative to that of the another one of the communications, when the at least one sidelink communication is communicated over the shared spectrum.

In some embodiments, the wireless communication device may determine the prioritization of the communications by: setting a higher priority to the at least one sidelink communication, in the prioritization of the communications relative to that of another one of the communications, when (e.g., if) a number of listen before talk (LBT) operations is larger than a defined threshold; or setting a lower priority to the at least one sidelink communication, in the prioritization of the communications relative to that of the another one of the communications, when the number of listen before talk (LBT) operations is larger than the defined threshold.

In some embodiments, the wireless communication device may perform a prioritized transmission over the shared spectrum according to the prioritization of the communications, by employing a defined type of channel access operation. The defined type may comprise at least one of: listen before talk (LBT) type 2A, 2B or 2C; an LBT type other than type 1 or frame based equipment (FBE); or a short control signaling transmission (SCSt) operation or no LBT operation.

In some embodiments, the wireless communication device may determine the prioritization of the communications prior to or after performing channel access for at least one of the communications, according to a configuration or pre-configuration.

In some embodiments, the wireless communication device may determine the prioritization of the communications according to at least one of: the communications whose listen before talk (LBT) operation provides an outcome that is successful, the communications over the shared spectrum or over one or more channels which are determined to be idle by channel access, or the communications over one or more spectrum other than the shared spectrum. The wireless communication device may perform a channel access operation over the shared spectrum.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
determining, by a wireless communication device, prioritization of communications at the wireless communication device, the communications including at least one sidelink communication,
wherein at least one of the communications is communicated over a shared spectrum.

2. The method of claim 1, wherein the communications further include at least one uplink (UL) transmission.

3. The method of claim 1, wherein the at least one sidelink communication comprises at least one physical sidelink feedback channel (PSFCH) transmission or at least one PSFCH reception.

4. The method of claim 1, wherein the at least one sidelink communication comprises at least one new radio (NR) communication and at least one evolved universal mobile telecommunications system terrestrial radio access (E-UTRA) communication.

5. The method of claim 1, wherein at least one of:
the at least one sidelink communication comprises at least one HARQ-ACK transmission communicated in a first physical uplink control channel (PUCCH); or
the communications further include at least one of: a HARQ-ACK transmission, a scheduling request (SR) transmission or a channel state information (CSI) transmission, communicated in a second PUCCH.

6. The method of claim 1, comprising one of:
determining, by the wireless communication device, the prioritization of the communications, prior to performing channel access for the at least one sidelink communication;
performing, by the wireless communication device, the channel access for the at least one sidelink communication, after the determination of the prioritization of the communications;
determining, by the wireless communication device, the prioritization of the communications, after performing the channel access for the at least one sidelink communication; or
performing, by the wireless communication device, the channel access for the at least one sidelink communication, prior to the determination of the prioritization of the communications.

7. The method of claim 6, wherein the channel access is performed using listen before talk (LBT) of type 1, 2A, 2B, 2C or frame based equipment (FBE).

8. The method of claim 1, wherein at least one of:
the communications include a first communication and a second communication;
the first communication or the second communication is communicated over a shared spectrum;
the first communication is a transmission and the second communication is a reception, at the wireless communication device;
the first communication is on a first frequency, and the second communication is on a second frequency;
the first communication is a prioritized transmission according to the prioritization of the communications, and the second communication is a prioritized reception according to the prioritization of the communications;
the first communication or the second communication is a prioritized sidelink communication according to the prioritization of the communications; or
the first communication or the second communication is a prioritized communication according to the prioritization of the communication over the shared spectrum.

9. The method of claim 8, comprising one of:
determining, by the wireless communication device, the prioritization of the communications, prior to performing channel access for at least one of the communications;
performing, by the wireless communication device, the channel access, after the determination of the prioritization of the communications;
determining, by the wireless communication device, the prioritization of the communications, after performing the channel access; or
performing, by the wireless communication device, the channel access, prior to the determination of the prioritization of the communications.

10. The method of claim 1, comprising:
receiving, by the wireless communication device via a higher layer signaling, an indication of a priority threshold for the at least one sidelink communication; and
determining, by the wireless communication device, the prioritization of the communications according to a comparison of a priority level of the at least one sidelink communication, and the priority threshold.

11. The method of claim 10, comprising:
determining, by the wireless communication device, that the at least one sidelink communication has:
a higher priority in the prioritization of the communications than another one of the communications, when the priority level is lower than the priority threshold, and
a lower priority in the prioritization of the communications than the another one of the communications, when the priority level is higher than the priority threshold.

12. The method of claim 1, comprising:
receiving, by the wireless communication device via a higher layer signaling, an indication of a priority offset for the at least one sidelink communication; and
determining, by the wireless communication device, the prioritization of communications according to a comparison of a priority level of the at least one sidelink communication adjusted by the priority offset, and a priority level of another one of the communications.

13. The method of claim 12, comprising:
determining, by the wireless communication device, that the at least one sidelink communication has:
a higher priority in the prioritization of the communications than the another one of the communications, when the priority level adjusted by the priority offset is lower than the priority level of the another one, and
a lower priority in the prioritization of the communications than the another one of the communications, when the priority level adjusted by the priority offset is higher than the priority level of the another one.

14. The method of claim 10, wherein the priority threshold or the priority offset is configured or preconfigured according to a least one of:
a success rate of listen before talk (LBT) operations;
a failure rate of LBT operations;
a channel busy ratio (CBR); or
a channel occupancy ratio (CR).

15. The method of claim 10, wherein the indication of the priority threshold or the priority offset includes at least one of:
an indication of more than one priority threshold or priority offset corresponding to different success rates of listen before talk (LBT) operations;
an indication of more than one priority threshold or priority offset corresponding to different failure rates of LBT operations;
an indication of more than one priority threshold or priority offset corresponding to different channel busy ratios (CBRs); or
an indication of more than one priority threshold or priority offset corresponding to different channel occupancy ratios (CRs).

16. The method of claim 1, comprising:
determining, by the wireless communication device, the prioritization of communications by:
setting a higher priority to the at least one sidelink communication, in the prioritization of the communications relative to that of another one of the communications, when the at least one sidelink communication is communicated over the shared spectrum; or
setting a lower priority to the at least one sidelink communication, in the prioritization of the communications relative to that of the another one of the communications, when the at least one sidelink communication is communicated over the shared spectrum.

17. The method of claim 1, comprising:
determining, by the wireless communication device, the prioritization of the communications by:
setting a higher priority to the at least one sidelink communication, in the prioritization of the communications relative to that of another one of the communications, when a number of listen before talk (LBT) operations is larger than a defined threshold; or
setting a lower priority to the at least one sidelink communication, in the prioritization of the communications relative to that of the another one of the communications, when the number of listen before talk (LBT) operations is larger than the defined threshold.

18. The method of claim 1, comprising:
performing, by the wireless communication device, a prioritized transmission over the shared spectrum according to the prioritization of the communications, by employing a defined type of channel access operation,
wherein the defined type comprises at least one of:
listen before talk (LBT) type 2A, 2B or 2C;
an LBT type other than type 1 or frame based equipment (FBE); or
a short control signaling transmission (SCSt) operation or no LBT operation.

19. The method of claim 1, comprising:
determining, by the wireless communication device, the prioritization of the communications prior to or after performing channel access for at least one of the communications, according to a configuration or pre-configuration.

20. A wireless communication device, comprising:
at least one processor configured to:
determine prioritization of communications at the wireless communication device, the communications including at least one sidelink communication,
wherein at least one of the communications is communicated over a shared spectrum.
